(19) United States
(12) Patent Application Publication
(10) Pub. No.: US 2009/0006524 A1
(43) Pub. Date: Jan. 1, 2009

(54) METHOD FOR PROVIDING USER FEEDBACK TO CONTENT PROVIDER DURING DELAYED PLAYBACK MEDIA FILES ON PORTABLE PLAYER

(75) Inventor: David H. Allen, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/768,483

(22) Filed: Jun. 26, 2007

(51) Int. Cl. G06F 15/16

(52) U.S. Cl. 709/202

(57) ABSTRACT

A computer program product stored on machine readable media including machine readable instructions for collecting input of a user from a personal media player, the product having instructions for playing a data file using the personal media player; recording the input on the personal media player; and transmitting the input to a processing system. Also disclosed is a computer program product for receiving input from a personal media player; and transmitting the input to the another party.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to personal media players, and particularly to techniques for providing feedback to providers of content.

2. Description of the Related Art

Personal media players are increasing in popularity. The personal media players are small and lightweight devices that people can carry. The personal media player can play computer data files also referred to as media files. The media files generally contain at least one of audio such as music and video such as a television program. Another type of computer data file is a “podcast.”

The podcast is a media file that is distributed over the Internet for immediate or later playback on the personal media players and personal computers. “Podcasting” is an automatic mechanism whereby media files are transferred from a server to a client (such as the personal computer) on a routine basis. Generally, with podcasting, the client receives extensible markup language (XML) files containing Internet addresses of the media files. A content provider begins by making the media file (for example, an MP3 audio file) available on the Internet. The content provider chooses which files to offer in a feed channel and a subscriber chooses among available feed channels. After the subscriber selects the feed channel, the server sends the media file to the client. The media file can then be played, replayed, or archived on the client as with any other computer file. The media file can also be stored by the personal media player where the media file can be played and replayed away from the client.

Most personal media players (e.g. an Apple “iPod,” produced by Apple, Inc. of Cupertino, Calif.) provide at least some resources for a subscriber (or user) of the podcast to input at least some information. For example, in the case of the iPod, an “On-the-Go” playlist feature permits the user to add a song to a playlist. More specifically, the user is able to hold down the center button of the device while a song is playing and the song is added to a playlist on the device. When the device is connected to the personal computer at the next opportunity, the “On-the-Go” playlist is transferred to and stored on the personal computer.

The content providers currently lack a way to request feedback from the user who might be listening to the podcast remotely (off-line) on the personal media player. For example, during the podcast, a particular product may be described that interests the user. The user may be asked in the podcast to go to a particular uniform resource locator (URL) address to request to be added to a mailing list for more information about the product. Generally, the user must write down or memorize the URL address and later, when back on-line, remember to connect to that URL address. Writing down or memorizing the URL address can be inconvenient or impossible for the user in some cases. Further, even if the user writes down or memorizes the URL address, the user may forget that he or she did so. As a result, an opportunity may be lost for interaction and commerce between the content provider and the user.

What are needed are techniques that provide for content providers receiving feedback from users of personal media players.

### SUMMARY OF THE INVENTION

The shortcomings of the prior art are overcome and additional advantages are provided through the provision of a computer program product stored on machine readable media including machine readable instructions for collecting input of a user from a personal media player, the product having instructions for playing a data file using the personal media player; recording the input on the personal media player; and transmitting the input to a processing system.

Also disclosed is a computer program product stored on machine readable media including machine readable instructions for transmitting user input collected by a personal media player to another party, the product having instructions for receiving the input from the personal media player; and transmitting the input to the another party.

Further disclosed is a method for providing user input collected by a personal media player, the method including playing a data file using the personal media player; recording input from the user of the personal media player on a list wherein the input includes a filename; transmitting the list to a processing system; and transmitting the list from the processing system to another party.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for collecting input of a user from a personal media player through a computer program product stored on machine readable media including machine readable instructions, the product having instructions for playing a data file using the personal media player; recording the input on the personal media player; and transmitting the input to a processing system.

As a result of the summarized invention, technically we have achieved a solution for transmitting user input collected by a personal media player to another party through a computer program product stored on machine readable media including machine readable instructions, the product having instructions for receiving the input from the personal media player; and transmitting the input to the another party.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a personal media player; and

FIG. 2 illustrates an exemplary method for providing input from a user to another party using the personal media player.

The detailed description explains the preferred embodiments of the invention, together with advantages and features, by way of example with reference to the drawings.

### DETAILED DESCRIPTION OF THE INVENTION

The teachings allow for a user to provide input to another party while playing a podcast on a personal media player. Specifically, in one embodiment, the user has an opportunity to respond to one of a specific query and choices offered during the podcast. The user responds by inputting a response to the personal media player. Generally, the response is input by depressing at least one input key on the personal media player. The response is then saved on the personal media player. Later, when the personal media player is connected to a computer, the response is transferred to the computer. Once the response is transferred to the computer, the response can be sent to at least one of a provider of the podcast and a vendor soliciting the response during the podcast. In general, the response can be in a form of a data file.

The data file can be sent by at least one of automatically such as when the computer is connected to the Internet and manually such as by email. Content of the data file alerts a receiver of the data file to voting, choices, selections, or other responses made by the user in response to one of the specific query and choices offered during the podcast. Upon receiving the data file, the receiver can react appropriately such as including the user's vote in poll results, sending information on a product to the user, or entering the user's order for a sales transaction.

The teachings can be used for at least one of polling, solicitation, off-line shopping, and other interactions with a sponsor of the podcast. For example, a particular product may be described during a podcast. The user may be asked if more information is desired to be sent as one of a link and text sent by email via the Internet. Alternatively, the user may be asked to receive a hardcopy of the information sent by regular post. A positive response initiated by pressing an input button, for example, indicates “yes.” A lack of response indicates “no.” Multiple choices (such as polling, etc.) can be given by indicating specific times and giving the user a specific time “window” to respond within for the respective choice. If no choices are selected during the window (null response), it is assumed that the user is not making a selection. One of a positive and negative (or null) response may also be used for interactions such as a request to be added to one of an email mailing list and a messaging group. An infrastructure of the personal media player is presented next.

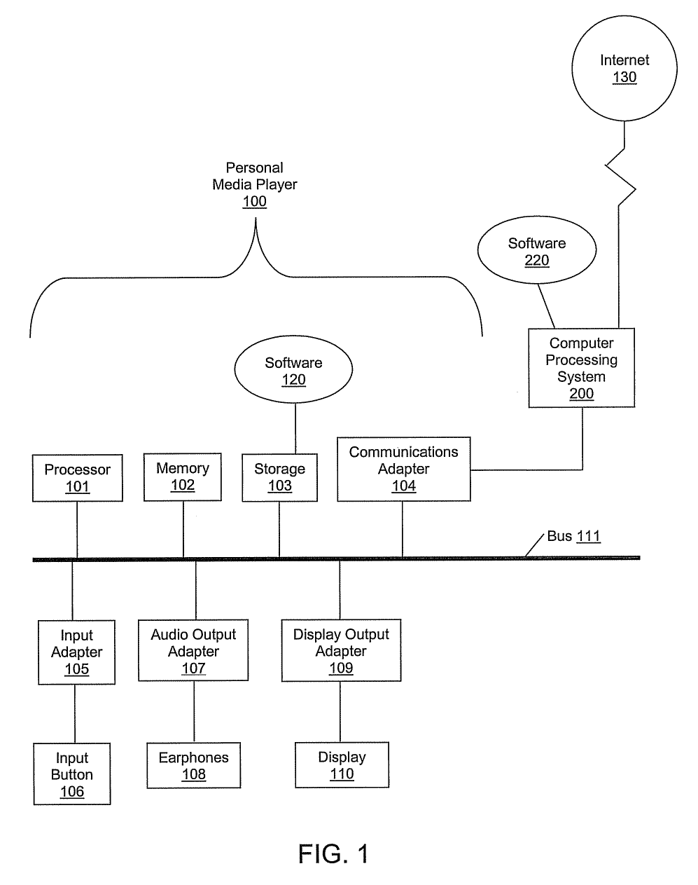

Referring now to FIG. 1, an exemplary embodiment of a personal media player 100 for implementing the teachings herein is depicted. The personal media player 100 has a processor 101 coupled to various components via bus 111. Memory 102 may be coupled to the bus 111 to provide at least one of read only memory (ROM) and random access memory (RAM). Storage 103 may similarly be connected to the bus 111 and provide for recording the input from the user. Also shown is a communications adapter 104 coupled to the bus 111. The communications adapter 104 enables the personal media player 100 to communicate with a computer processing system 200.

The computer processing system 200 includes various components necessary to communicate with the personal media player 100 and with another party through the Internet. Exemplary components include, without limitation, at least one processor, storage, memory, input devices, output devices and the like. Components of the system 200 provide for the storage and execution of software related to receiving the input from the personal media player 100 and transmitting the input to another party via the Internet. As these components are known to those skilled in the art, these are neither depicted in any detail nor discussed further herein.

FIG. 1 further depicts an input adapter 105 for receiving input from at least one input button 106. The personal media player 100 also includes an audio output adapter 107 for connecting earphones 108 to the bus 111. A display output adapter 109 provides for connecting a display 110 to the bus 111.

As disclosed herein, the personal media player 100 includes machine readable instructions stored on machine readable media (for example, the storage 103) for allowing the user to provide input to the personal media player 100. As disclosed herein, the instructions are referred to as “podcast response software 120.” Also disclosed herein, the computer processing system 200 includes “podcast response transfer software 220” for transferring the input, such as a response, from the personal media player 100 to another party.

As used herein, the another party can be at least one of a podcast originator, a podcast provider, a podcast sponsor, an advertiser, a charitable organization, and a party designated by the podcast.

The podcast response software 120 is related to the podcast response transfer software 220. The podcast response software 120 is used to collect input from the user of the personal media player 100. The podcast response transfer software 220 is used to receive the input from the personal media player 100 and transfer the input to another party. The podcast response software 120 and the podcast response transfer software 220 are used together to receive input from the user of the personal media player 100 and provide the input to another party.

In an exemplary embodiment of the teachings herein, the podcast is transferred to the personal media player 100 and stored in the storage 103 as a series of audio files. The audio files are played back sequentially. During playback of some of the audio files, the user is asked to depress the input button 106 for an affirmative response to a question. Depressing the input button 106 during the audio file currently playing records the affirmative response. The affirmative response is recorded by adding the filename of the audio file currently playing to an input list. The presence of the filename in the input list serves as a record of the affirmative response of the user. Conversely, if the filename is not present in the input list, then the response to the question is negative. The input list contains a list of all affirmative responses by the user. The personal media player 100 is next connected to the computer 200.

When the personal media player 100 is connected to the computer 200, the input list can be transferred to the computer 200. The input list can then be transferred by one of automatically and manually to the podcast originator for example. Once transferred to the podcast originator, the affirmative responses would be used by the podcast originator for purposes related to the questions (e.g. add the user to the mailing list, ship the requested information, etc.). An example is provided next depicting a series of files played on the personal media player 100.

A sequence of files as follows can be used to provide for a user to vote for one (or zero) of two contestants in a contest. File 001.mp3 states “If you wish to vote for Contestant A, please push the center button on your device within the next thirty seconds.” File 001a.mp3 provides 30 seconds of silence, music, or other content. File 002.mp3 states “If you wish to vote for Contestant B, please push the center button on your device within the next thirty seconds.” File 001b.mp3 provides 30 seconds of silence, music, or other content. File 003.mp3 states “This concludes voting.”

If the user pushes the input button 106 during the playing of the file 001a.mp3, the input list will record filename 001a.mp3. When the user connects the personal media player 100 with the computer 200, the input list can be transmitted one of manually and automatically to the podcast originator. The input list can also be saved for later transmission. The podcast originator can note a user identification such as an email address and the filename 001a.mp3 on the input list and record the vote for Contestant A.

With respect to the above embodiment, the personal media player 100 can be implemented with the Apple iPod. The center button of the Apple iPod can implement the input button 106 and the “On-the-Go” playlist can implement the input list.

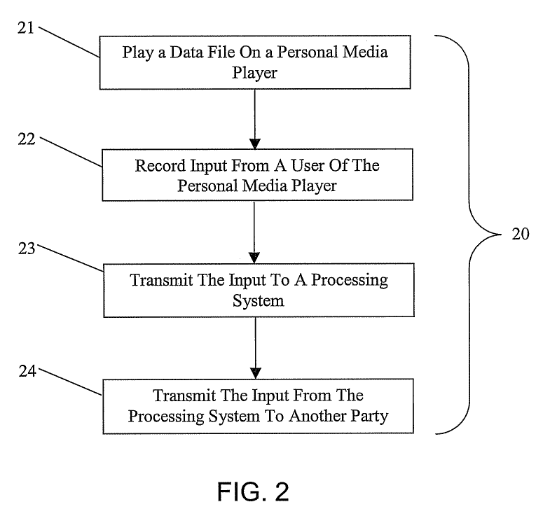

FIG. 2 illustrates an exemplary method 20 for providing input from a user to another party using the personal media player 100. A first step 21 calls for playing a data file using the personal media player 100. Generally, the data file may include a question to which the user can provide a response. In other embodiments, a question may not be presented but input may be provided by the user with respect to a context of the podcast. For example, a podcast may present a sampling of music in the context that depressing the input button 106 during a song will purchase that song. A second step 22 calls for recording input from the user. Generally, the input can result from depressing the input button 106. A third step 23 calls for transmitting the input to the computer processing system 200. A fourth step 24 calls for transmitting the input from the computer processing system 200 to another party.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to personal media players, and particularly to techniques for providing feedback to providers of content.

2. Description of the Related Art

Personal media players are increasing in popularity. The personal media players are small and lightweight devices that people can carry. The personal media player can play computer data files also referred to as media files. The media files generally contain at least one of audio such as music and video such as a television program. Another type of computer data file is a “podcast.”

The podcast is a media file that is distributed over the Internet for immediate or later playback on the personal media players and personal computers. “Podcasting” is an automatic mechanism whereby media files are transferred from a server to a client (such as the personal computer) on a routine basis. Generally, with podcasting, the client receives extensible markup language (XML) files containing Internet addresses of the media files. A content provider begins by making the media file (for example, an MP3 audio file) available on the Internet. The content provider chooses which files to offer in

What is claimed is:

1. A computer program product stored on machine readable media comprising machine readable instructions for collecting input of a user from a personal media player, the product comprising instructions for:
playing a data file using the personal media player;
recording the input on the personal media player; and
transmitting the input to a processing system.

2. The product as in claim 1, wherein the input comprises a filename.

3. The product as in claim 1, wherein the input comprises a list of responses.

4. A computer program product stored on machine readable media comprising machine readable instructions for transmitting user input collected by a personal media player to another party, the product comprising instructions for:
receiving the input from the personal media player; and
transmitting the input to the another party.

5. The product as in claim 4, wherein the transmitting comprises transmitting at least one of automatically and manually.

6. A method for providing user input collected by a personal media player, the method comprising:
playing a data file using the personal media player;
recording input from the user of the personal media player on a list wherein the input comprises a filename;
transmitting the list to a processing system; and
transmitting the list from the processing system to another party.
